(19) United States
(12) Patent Application Publication
(10) Pub. No.: US 2010/0263596 A1
(43) Pub. Date: Oct. 21, 2010

(54) Weight Controlled Pet Feeding System

(75) Inventors: ANKE SCHUMANN, ARLINGTON, MA (US); YILDIRAY SAGER, SOMERVILLE, MA (US)

Correspondence Address: YILDIRAY SAGER, 12 STANFORD TER. FL.2, SOMERVILLE, MA, 02143, US

(73) Assignee: YILDIRAY SAGER, SOMERVILLE, MA (US)

(21) Appl. No.: 12/427,740

(22) Filed: Apr. 21, 2009

(51) Int. Cl. A01K 5/00

(52) U.S. Cl. 119/51.02

(57) ABSTRACT

According to the current invention, the new pet feeding system provides a controlled food release to aid individual weight management of a pet. This is what sets the proposed feeder apart from its competitors. The pet feeder includes an automatic computerized weight and food release mechanism. Individual pet information such as current weight, aimed for weight, and pet information is entered via pin pad instructions, the feeder calculates exact amount of food. At each feeding the pet steps on a weight scale which automatically updates pet's weight information and recalculates food output. Another aspect of the invention is the automatic storage and update of the pet's data and weight loss progress. Through a wireless device, the pet's information of weight, feeding times and food amount, food type, and daily caloric intake is saved onto a portable electronic storage device.

### FIELD OF THE INVENTION

This invention relates in general to a pet feeding system, and in particular to a weight controlled automated pet feeding system with networking capability.

### BACKGROUND

U.S. Pat. No. 6,766,766 is about a pet care center with refrigerated automatic feeder. A carousel type food tray is divided into a plurality of pie shaped containers, with an adjacent pair of containers made accessible to a pet, and the others maintained in a refrigerated condition in a refrigerated compartment of the pet care center. A tray for receiving animal waste is attachable to the refrigerated compartment. U.S. Pat. No. 6,062,166 is about an automatic pet feeder system which allows a user to monitor the operation of the pet feeding and determine whether or not the pet feeding system is operating normally by placing a phone call to his or her house. The invention includes both a water reservoir and food reservoir which are each in connection with a separate bowl while monitoring sensors in the reservoirs and bowls determine the level of food and/or water and which when necessary indicate through a monitoring circuit to a controller to actuate an inlet valve to allow either food or water to enter into the appropriate bowl. U.S. Pat. No. 5,404,838 is about an automatic pet feeder that comprises a tubular food reservoir with a food replenishing port and a feeding port. The food replenishing port is in the upper end of the food reservoir and is sealed with a cap when in use. The feeding port is located adjacent the lower end of the food reservoir and has a pivotally mounted cover plate, sealing its otherwise open end, that can be pivoted out of the way by a pet to gain access to food in the feeding port. U.S. Pat. No. 5,363,805 is about an automatic pet feeder which consists of a cabinet to sit upon a flat surface. A hopper is built into the cabinet for storing solid food therein so a bowl may be externally positioned adjacent the cabinet on the flat surface. A device is for dispensing some of the solid food from the hopper directly into the bowl, so that a pet can feed from the bowl. An apparatus is provided for programming the dispensing device to control the frequency and the amount of the solid food delivered into the bowl. U.S. Pat. No. 5,345,892 is about an automatic pet feeder that comprises a vertically extending tubular food reservoir, a tubular food loading port adjacent an upper end of the tubular food reservoir and at least one tubular feeding port adjacent a lower end of the tubular food reservoir. The tubular food reservoir is closed at its upper and lower ends and is provided with a means at its upper end for either non-rotatably or rotatably suspending the automatic pet feeder above the ground. U.S. Pat. No. 5,299,529 is about an automatic feeder that includes a computerized dispenser for dispensing different programmed quantities of food for each meal (e.g., 1-10 cups of dry food) to an animal at up to ten programmed times. The computerized dispenser includes food-dispensing components for dispensing food and, preferably, water-dispensing components for dispensing water. The computerized dispenser also includes a programmed microcomputer and integrated control circuitry operatively coupled to the food-dispensing components for automatically controlling the food-dispensing components in order to dispense different programmed quantities of food for each meal at programmed times. U.S. Pat. No. 5,259,336 is about a combined automatic pet waterer and feeder in which a water dish portion is designed to receive the neck of a commonly available soft drink bottle for a storage tank. Water flows from the bottle through a bottle-holding support portion into a water reservoir section for drinking by an animal. A food dish portion has a food container support section and a food reservoir section for receiving food from the food container support section. U.S. Pat. No. 4,733,634 is about an automatic home pet feeder which when set to go off at a pre-determined time will automatically release food and water into trays for a pet to eat and drink. An automatic computerized time setting device with a voice recording of the pet owner will sound at the pre-determined time to notify the pet that it's feeding time. Patent Application 20080289580 is about an automatic pet feeder of for feeding pets predetermined quantity of food or medication at predetermined times while the owner is absent or otherwise engaged is disclosed. The pet feeder comprises a base, a feeding bowl with pie shaped divisions, a timer module, a bowl cover, handle to bowl cover and locking mechanism to hold the entire unit in place. A timer is provided with voice recording facility and also initiates programmed feeding schedules. The programming of the timer determines when the feeder cover is indexed so that the pet may have access to the food provided in it. This programming can be done through the timer interface RF or IR remotes and or through an USB port interface to a computer. Patent Application 20040194714is about an integrated type Internet pet food feeder for use at home and an Internet pet food feeding system using the same, which can monitor a pet using a wire/wireless Internet and controlling an automatic supply of food at a remote location while monitoring the pet. The food feeding system comprises a remote system connected to a computer or a control system of a pet food feeder through the wire/wireless Internet network, and for transmitting a command of controlling a PC camera or a digital camcorder and an automatic opening/closing door via a web browser, and a pet food feeder having a food tank and a food tub to which the food is supplied from the tank through the automatic opening/closing door, and a computer or a control system connected to an Internet network, and for receiving the control command from the remote system to open/shut the automatic opening/closing door via a door driving unit, controlling the PC camera or the digital camcorder to take the image and transmitting the taken image to a remote system through the wire/wireless Internet network

### SUMMARY OF THE INVENTION

Typically, setting the food and timing are limited and can not be individualized based on the Pet's need in current automatic pet feeding systems. In today's market, pet owners are more conscious of their pet's health and they are willing to invest more for the individual pet needs. Excessive weight gain in pets is rising and causing health related problems. The owners are looking for the convenience of automatic individualized pet feeding that simultaneously allows for improving the health and longevity of the pet's life. Further aspects are to provide an automatic pet feeder that is simple and easy to use while being of superior quality.

According to the current invention, the new pet feeding system provides a controlled food release to aid individual weight management of a pet. This is what sets the proposed feeder apart from its competitors. The pet feeder includes an automatic computerized weight and food release mechanism. Individual pet information such as current weight, aimed for weight, and pet information is entered via pin pad instructions, the feeder calculates exact amount of food. At each feeding the pet steps on a weight scale which automatically updates pet's weight information and recalculates food output. A veterinarian must be consulted to determine the pet's healthy weight and regular check ups with the pet's veterinarian are required during the weight loss program.

Another aspect of the invention is the automatic storage and update of the pet's data and weight loss progress. Through a wireless device, the pet's information of weight, feeding times and food amount, food type, and daily caloric intake is saved onto the portable electronic storage device. A special program displays the information on the computer for the user, as well as the pet's veterinarian's. This allows easy progress updates and health monitoring of the pet.

### DESCRIPTION OF THE DRAWINGS

FIG. 1 illustrates the weight control automated pet feeder according to the invention 100.

FIG. 2 illustrates individual components that the automated pet feeder system 100 comprises according to the invention.

FIG. 3 shows components and functionalities of the user interface of the automated pet feeder system according to the invention.

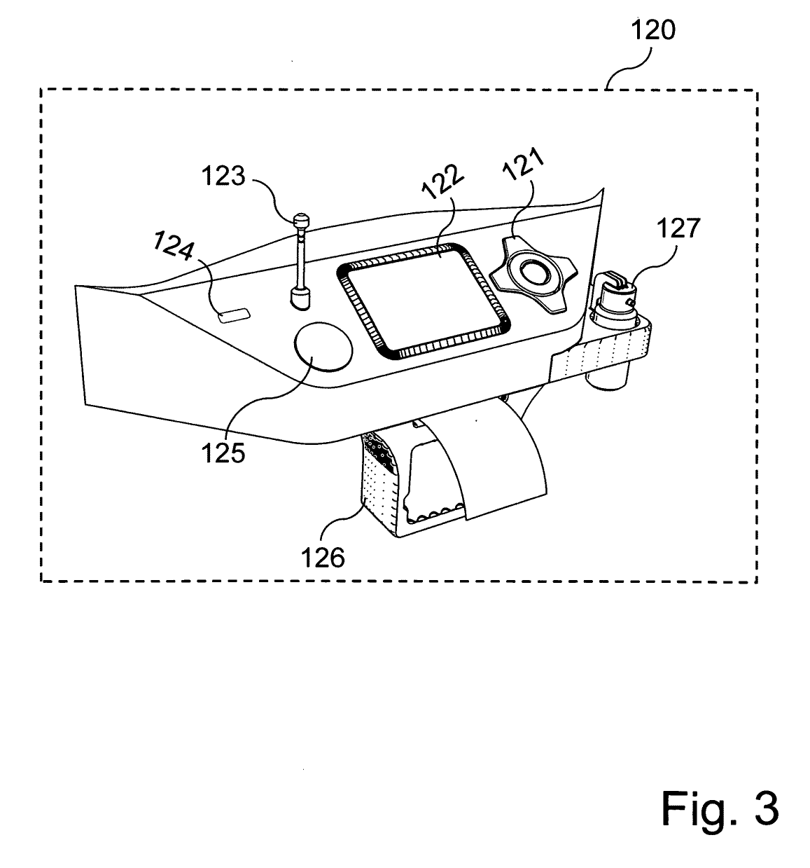

FIG. 4 denotes the menu architecture according to the invention.

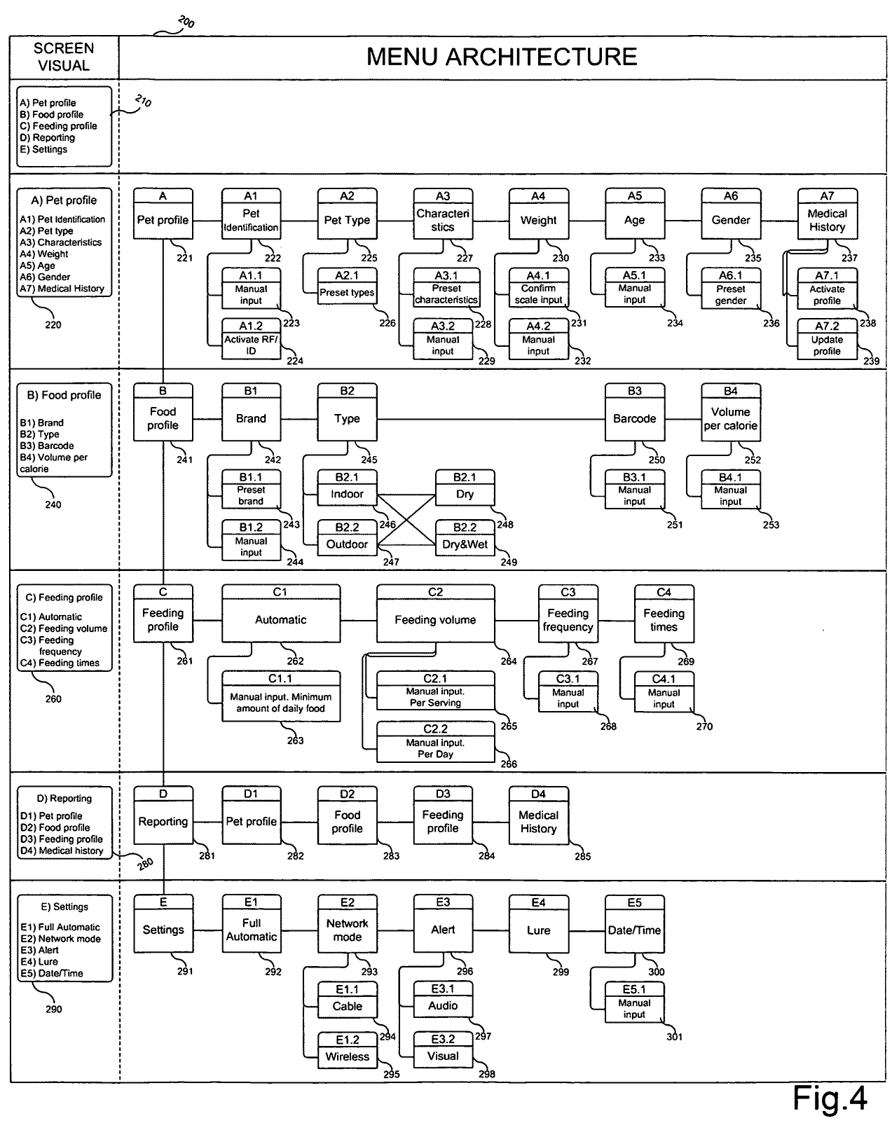

### DETAILED EMBODIMENT

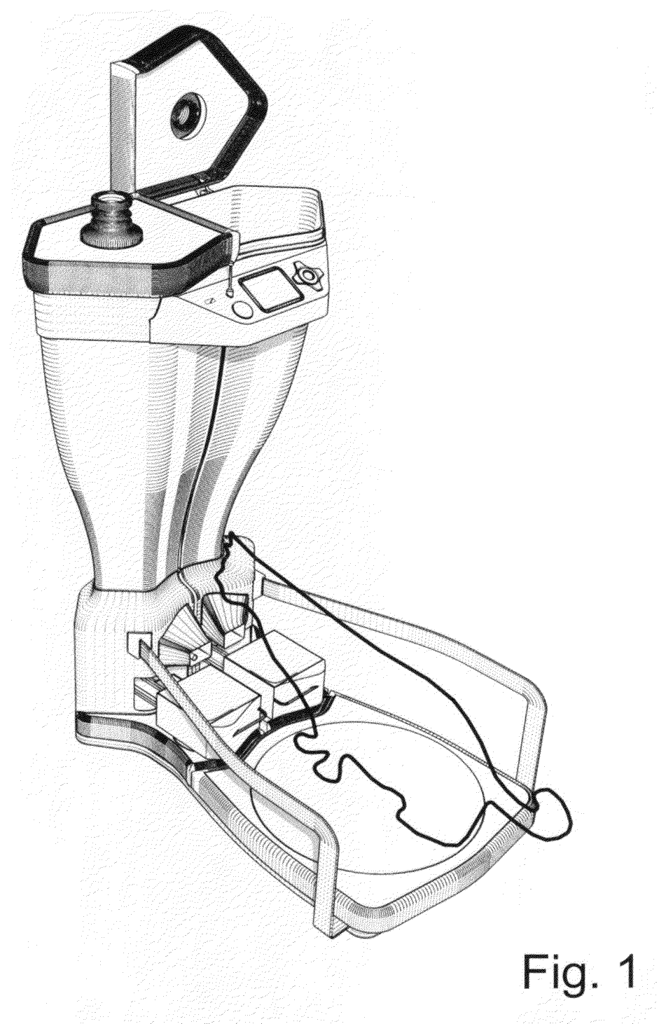

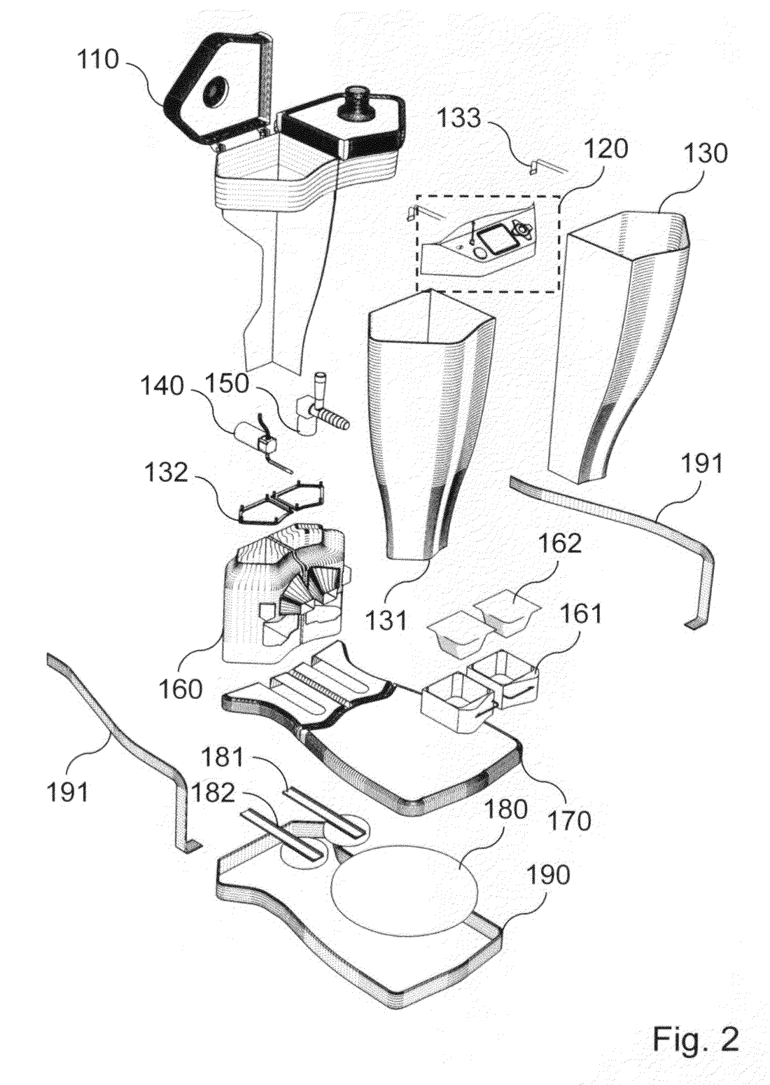

This invention describes an automated pet feeder system 100 as shown in FIG. 1. It comprises, as shown in FIG. 2, a dry food container 130, a water container 131, a water and food level measuring springs 132, water and food level measuring conductive cables 133, a container support with a hinged lid 110, a water pump 140, a dry food feeder 150, a water and dry food plate holding drawer 161, a water and dry food replenishment plate 162, a dry food scale 181, a water scale 182, pet scale 180, a scale base 190, a pet directing handle 191, a scale covering hull 170, smart pet feeder (SPF) command board 120, SPF body base 160. According to a different embodiment of the invention, the water and food level measurement can be performed via sensors that are implemented in the form of an electronic circuit or electromechanical mechanisms.

The dry food container 130 is used to hold dry food. Its volume allows to store dry food amount sufficient for pet's feeding for more than one day.

The water container 131 holds water supply of the pet.

The container support with a hinged lid 110 holds both the water container 131 and the food container 130 in an upright position and prevents spilling of food and water from the containers 131, 130.

The water pump 140 takes water from the water container 131 and delivers the water into the water plate 162. The water pump 140 comprises a sensor for measuring flow density or volume according to one embodiment of the invention. Therefore, the sensor provides flow density and volume information to the control board 120. If the water amount sufficient to fill the water plate 162 flows from the pump 140, the control board 120 signals the pump 140 to stop delivering water into the water plate 162. In one embodiment of the invention, the water scale 182 measures the amount of water in the water plate 162, and provides feedback to the control board 120. Then, the control board signals the water pump 140 to continue its operation or to stop. If the water plate 162 does not contain enough water for the pet, the control board signals the water pump 140 to start delivering water into the water plate 162. As soon as the water scale 182 measures enough water amount to fill the plate, it sends a signal to the control board. Then, it is up to the control board to signal the water pump 140 to stop its water delivery.

The dry food feeder 150 takes dry food from the dry food container 130, and delivers the dry food into the dry food plate 162. The control board is also provided with a feedback by the dry food scale 181 on the dry food amount in the dry food plate 162. If the dry food amount in the dry food plate 162 needs to be replenished, the control board signals the dry food feeder 150 to turn on. Then, the dry food feeder 150 starts delivering dry food into the dry food plate 162. As soon as the dry food scale 181 measures sufficient food in the dry food plate 162, it signals the control board accordingly. It is up to the control board 120 whether to stop the dry food feeder 150.

A dry food/water plate drawers 161 hold the dry food/water replenishment plates. There are two drawers 161: one to hold water plate and the other to hold the dry food plate.

According to the invention, the scale base comprises at least three scales: a pet scale 180 to measure weight of the pet, dry food scale 181 and a water scale 182. The dry food scale 181 measures the dry food amount in the dry food replenishment plate 162 and provides control signaling to control board 120. The water scale 182 measures the amount of water in the water replenishment plate 162 and provides control signaling to the control board. The container support 110 is used to hold the SPF command board 120. The scale covering hull 170 protects and covers the three scales.

The pet directing handle 191 ensures that the pet stands on the pet scale 180 for proper weight measurement, while the pet eats/drinks dry food/water.

The SPF command board comprises a multi-functional navigation board 121, a display 122, a communication antenna 123, a USB interface 124, speaker unit 125, a mini printer 126 and an odor spray unit 127. The navigation board 121 provides buttons for right, left, down and up movements in menu items and also an ENTER/OK button. The USB interface 124 is used to upload and download programs to the product and also to download stored data and statistics about eating and weight profile of the pet. The speaker unit 125 provides audio alerts to the user. A mini printer 126 is used to print out data comprising pet profile, pet's eating statics, product specifications and etc. The odor spray unit 127 is used as a lure to attract the pet to the food plates 162.

The product menu 210 comprises pet profile 220, food profile 240, feeding profile 260, reports 280 and settings 290.

The pet profile menu 220-221 comprises the following menu items: pets' identification 222, pet type 225, pet characteristics 227 that further comprises preset characteristics 228 and manually input characteristics 229, pet's weight 230 further comprising confirmation for scale input 231 and manual weight input 232 options, pet's age 233 that also provides an option for manual input 234, gender 235 comprising a field for preset gender 236, medical history record 237 that further comprises entries for activating profile 238 and updating a medical history profile 239.

Pet name menu item provides a manual input 223 or the name can be read from an Radio Identification ID (RFID) tag 224. Pet type item 225 indicates the type of the cat. For instance, it can be preset 226. Pet characteristics menu item 227 provides options to reset pet characteristics 228 and to manually enter information 229. The weight menu item 230 comprises scale input confirmation 231 and manual input mode 232. The age menu item 233 provides options for manual input 234. The medical history 237 comprises profile activation mode 238 and profile update mode 239.

The food profile menu 240-241 comprises the following menu items: food brand 242, food type 245, food barcode information 250, which can be entered manually 251, volume per calorie 252. The brand 242 can be preset 243 and can be entered manually 244. The type 245 indicates whether it is an indoor 246 or outdoor 247 consumption and also whether it is a dry 248, or dry and wet food 249. The volume per calorie 252 for the select food type is entered by the user manually 253.

The feeding profile menu 260-261 consists of the following menu items: Operation mode (automatic) 262, feeding volume 264, feeding frequency 267, feeding times 269. Operation mode comprises an option for manual input for minimum amount of daily food 263, the feeding volume 264 comprises two options: one manual input per serving 265 and manual input per day 266. The feeding frequency 267 can be entered manually 268. The feeding times 269 can be also set manually 270 by the user.

The reporting menu 280-281 comprises reports for pet profile 282, food profile 283 and feeding profile 284, and medical profile 285.

The settings menu 290-291 comprises a fully automatic mode 292, network mode 293, alert mode 296, lure 299 and date/time 300. In the network mode 293, the interface for networking should be selected. The networking interface comprises cable (e.g., Ethernet) 294, wireless 295 and etc. The alert 296 comprises audio alerts 297 and visual alerts 298. The date/time 300 can entered by the user manually 301, or it can be set via a provided internet connection over the web.

What is claimed is:

1. An automated smart pet feeder system that identifies a pet, controls and optimizes the amount and frequency of food and water to release for feeding of the identified pet.

2. The pet feeder system of claim 1, wherein the system comprises a water scale, a dry-food scale, a scale base, dry food container, water container, dry food feeder, water pump, a smart pet feeder command board, a mini printer.

3. A system of claim 2, wherein the smart pet feeder command board comprises multifunctional navigation buttons in a programming menu, a display, a wireless communication unit, a Universal Series Bus interface and driver, an audio speaker, an odor releasing spray, a network interface, data processing unit and data storage unit.

4. A system of claim 3, wherein the programming menu comprises pet profile, food profile, feeding profile, reports, configuration and settings.

5. A system of claim 4, wherein the pet profile comprises information about pet's identification, pet type, pet's gender, pet's current weight, pet's age, pet characteristics and medical history.

6. A system of claim 4, wherein the food profile comprises food brand, food type, food barcode, and food volume per calorie.

7. A system of claim 4, wherein the feeding profile comprises information about automatic and manual feeding settings, feeding volume per serving and per day, feeding frequency for the automated mode and manual mode, and feeding times.

8. A system of claim 4, wherein the reports comprise reports on pet profile, reports on food profile, reports on feeding profile, reports on medical history.

9. A system of claim 4, wherein the settings comprise operation in an automated mode, networking mode settings, alert settings, date/time stamp for past alerts and date/time stamp for scheduled alerts, and lure settings.

10. A system of claim 2, wherein the mini printer is used to Print out information regarding the profiles in the claim of 4.

11. A system of claim 3, wherein the universal serial bus interface is used to Program the pet feeder system described in claim 1, and to upload and download profile data.

12. A system of claim 3, wherein the networking interface is used to read settings of the profiles described in claim 3 and to change settings of the Profiles described in claim 3.

13. A system of claim 1, wherein the optimum food amount to release for feeding of the pet is determined based on pet's profile, food profile, and feeding profile.

14. A wireless communication unit of claim 3, wherein the communication unit is used to retrieve calorie consumption information from another wireless tag unit on the pet.

15. A wireless tag unit of claim 14, wherein the unit comprises an accelerometer and various other sensors to compute mobility related variable values including distance traversed by the pet, calorie burned and etc.
